(19) United States
(12) Patent Application Publication
(10) Pub. No.: US 2011/0126276 A1
(43) Pub. Date: May 26, 2011

(54) CROSS PLATFORM GATEWAY SYSTEM AND SERVICE

(75) Inventors: Kim Rubric Dykeman, San Francisco, CA (US); Gevorg Gevorgyan, Glendale, CA (US)

(73) Assignee: Rovi Technologies Corporation, Santa Clara, CA (US)

(21) Appl. No.: 12/622,811

(22) Filed: Nov. 20, 2009

(51) Int. Cl. H04L 9/32

(52) U.S. Cl. 726/12

(57) ABSTRACT

A method, system, and apparatus for delivering content to a user of a registered platform are provided. Assets retrieved from a number of content sources may be stored on a database at a service provider. Information related to a number of content items retrieved from the assets may be presented to the user of the registered platform. In response to a request from the user, a content item associated with a content source may be delivered to the user without a need for user authentication.

### COPYRIGHT NOTICE

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2008-2009, Macrovision Solutions Corporation and Rovi Corporation, All Rights Reserved.

### BACKGROUND

As the market for consumer electronics (CE) expands, more and more sophisticated CE devices become available. Today's CE device manufacturers are facing demands for more advanced features which may only be satisfied with high technology solutions. The use of processing power in many CE devices facilitates providing more technically advanced features in more compact and less expensive CE devices, such as various hand-held devices.

Also, network connectivity is becoming a new trend in more CE devices. For example, new models of television sets manufactured by various vendors are equipped with Internet capabilities for content delivery without the need for a personal computer. Such Internet connectivity features may drastically improve the functionality of CE devices that utilize this feature.

### RELATED APPLICATIONS

The present patent application is related to the following patent applications each assigned to a common assignee:

United States Patent Application [CP0022] entitled, “DATA DELIVERY FOR A CONTENT SYSTEM,” which is hereby incorporated by reference.

United States Patent Application [CP0023] entitled, “CONTENT INTEGRATION FOR A CONTENT SYSTEM,” which is hereby incorporated by reference.

United States Patent Application [CP0043] entitled, “CONTENT RECOMMENDATION FOR A CONTENT SYSTEM,” which is hereby incorporated by reference.

United States Patent Application [CP0044] entitled, “CONTENT INGESTION FOR A CONTENT SYSTEM,” which is hereby incorporated by reference.

United States Patent Application [CP0036] entitled “MANAGING DIFFERENT FORMATS FOR MEDIA FILES AND MEDIA PLAYBACK DEVICES,” which is hereby incorporated by reference.

United States Patent Application [CP0046] entitled “USER INTERFACE FOR MANAGING DIFFERENT FORMATS FOR MEDIA FILES AND MEDIA PLAYBACK DEVICES,” which is hereby incorporated by reference.

### BRIEF DESCRIPTION OF THE DRAWINGS

Embodiments are illustrated by way of example and not limitation in the figures of the accompanying drawings, in which:

FIG. 1 illustrates an example architecture for delivering content to a user of a user platform, according to various embodiments;

FIG. 2 illustrates an architecture for delivering content and/or content information to a user platform, according to various embodiments;

FIG. 3 illustrates a service provider for delivering content to a user of a user platform, according to various embodiments;

FIG. 4 is a flow diagram illustrating a method of delivering content to a user of a user platform, according to various embodiments;

FIG. 5 illustrates a process for registering a user and/or a user platform with a content source;

FIG. 6 illustrates an example user platform, according to various embodiments;

FIG. 7 illustrates example interactions between various entities in the architecture shown in FIG. 1, according to various embodiments;

FIG. 8 illustrates an example functional relationship between various entities in the architecture shown in FIG. 1, according to various embodiments;

FIG. 9 illustrates example applications facilitating device data communications for delivering content to a user of a registered platform, according to various embodiments;

FIG. 10 illustrates an example periodic ingestion of service catalog data from a content source, according to various embodiments;

FIG. 11 illustrates an example registration and linking, according to various embodiments;

FIG. 12 illustrates an example account authentication, according to various embodiments;

FIG. 13 illustrates an example workflow for delivery of a list of available content items to a registered platform, according to various embodiments;

FIG. 14 illustrates an example of an e-commerce implementation for delivery of content to a user of a registered platform, according to various embodiments;

FIG. 15 illustrates an example of direct delivery from the content source, according to various embodiments; and

FIG. 16 illustrates a diagrammatic representation of a machine in the example form of a computer system.

### DETAILED DESCRIPTION

A computer-implemented method, system, and apparatus for delivering content are described. In the following description for the purpose of explanation, numerous examples having example-specific details are set forth to provide an understanding of example embodiments. It will be evident, however, to one of ordinary skill in the art that the present examples may be practiced without these example-specific details, and/or with different combinations of the details than are given here.

Some example embodiments described herein also include a system and method for delivering content to a user of a registered user platform. Assets retrieved from a number of content sources may be stored in a database at a service provider or the content itself can be retained at the content source for direct delivery to a user platform as described in more detail herein. The term “asset” can be taken to include, but is not limited to, one or more collections of content, content information and metadata associated with the content, e.g., descriptions, synopses, biographies, trailers, reviews, links, etc., and content source catalogs. Each asset can contain a content item and content information related to the content item. Content information related to a number of content items retrieved from the assets may be presented to the user of the registered user platform. In response to a request from the user, a content item associated with a content source may be delivered directly to the user platform without a need for explicit user authentication. The service provider may authenticate on behalf of the user so that the user does not need to be asked to authenticate each time the user employs the registered user platform to order content from the content source.

In example embodiments, the content may comprise, but is not limited to, digital content including electronic publications such as electronic books, journals, newspapers, catalogs, and advertisements, and multimedia content including audio and video content. Content sources can be conventional television or radio broadcasters, Internet sites, printed media authors or publishers, magnetic or optical media creators or publishers, and the like.

A registered user platform, e.g., a registered user device or a set of user devices, may comprise a consumer electronic (CE) device including additional hardware and software that enables the consumer electronic device to register with a service provider. Some consumer electronic devices, such as television sets, may enable access to the Internet by being coupled to a computer, e.g., a personal computer (PC) such as a laptop or a desktop computer, etc. The registered consumer electronic device may be used by a user to access content from various content sources such as, for example, Amazon, Netflix, Napster, CBS, etc., over the Internet, directly without connection through a computer, as discussed in detail below.

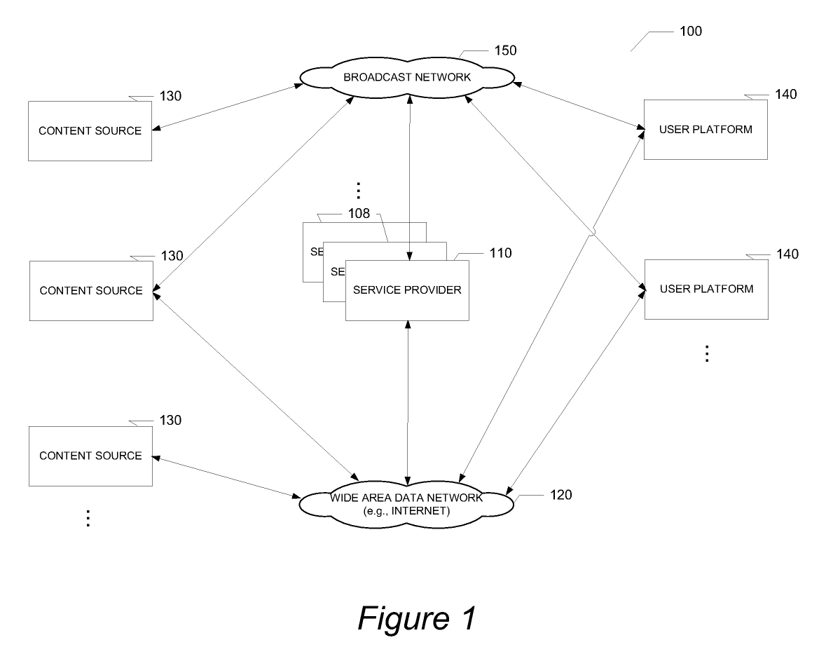

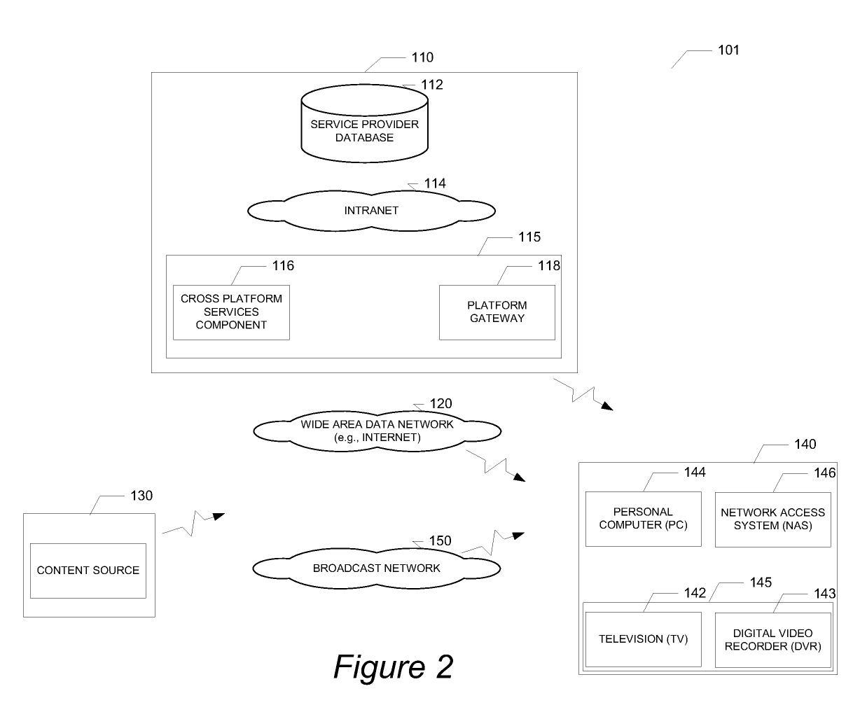

FIGS. 1 and 2 illustrate example architectures 100 and 101 for delivering content and content information to a user of a user platform 140, according to various embodiments. Preferably, the user platform 140 receiving the content and/or content information comprises a registered user platform. Registration for a user platform 140 is further described below in relation to FIGS. 2-5. The user platform 140 may gain access to one or more content items from a content source 130, e.g., a third party content source such as Amazon, Netflix, Napster, CBS, etc., via services of a service provider 110 including, for example, Macrovision Corporation, Rovi Corporation, or another host or service provider. The user platform 140 may comprise, for example, a television (TV) 142, a digital video recorder (DVR) 143, or other user devices shown under user platforms 140. The user platforms 140 may also include a computer (PC) 144 and/or a network attached storage device (NAS) 146, such as a network router or a wireless access point device that may optionally form a home network. The user platforms 140 may also include a set-top box. The user platforms 140, for example, the television 142, the computer 144, and/or the set-top box may be coupled to the content source 130 via a broadcast network 150. The user platforms 140 and content sources 130 may have access to the wide-area data network 120, e.g., the Internet, as well.

FIG. 1 also illustrates that an equivalent configuration of architecture 100 and 101 of various embodiments can include multiple content information processing sites 108, each managing a portion of the functionality provided as described herein. A particular embodiment may include an additional layer, called the Partner Sites, wherein each Partner Site is hosted on a separate server and each Partner Site communicates with the user platform 140 and/or the content source 130 as described in more detail herein. In this embodiment, each Partner Site can manage a subset of the available content and content information from content sources 130. Further, it will be apparent to those of ordinary skill in the art that another equivalent configuration includes a portion of the functionality provided by the user platform 140 being downloaded from the service provider 110 and/or processing sites 108, such as a collocation facility, to the user platform 140 and executed locally at the client and/or user location. In any of these alternative configurations, the architecture 100 or 101 of various embodiments provides and supports enabling content access by user platforms as described in more detail herein.

In an example embodiment shown in FIG. 2, the service provider 110 may comprise a service provider database 112, such as a content information database coupled via an intranet 114 to hosted services 115. The hosted services 115 may comprise a cross platform services (CPS) component 116 and a cross platform gateway (CPGW) or “platform gateway” 118. The platform gateway 118 may act as an interface between the user platform 140 and the service provider 110. The cross platform services component 116 may be responsible for processing requests from the user platform 140 via interactions with the content sources 130, as described in more detail below.

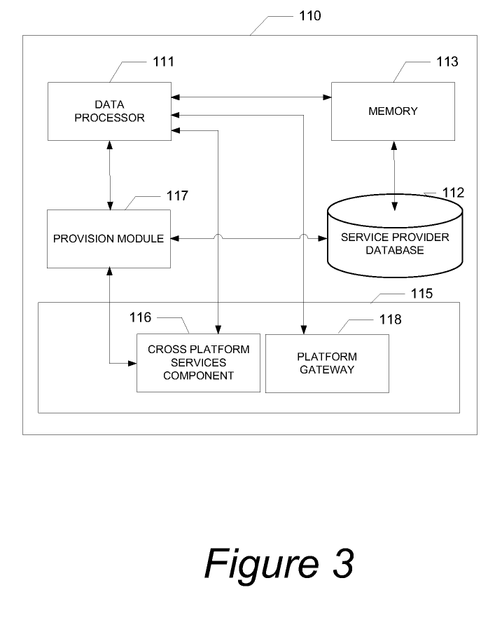

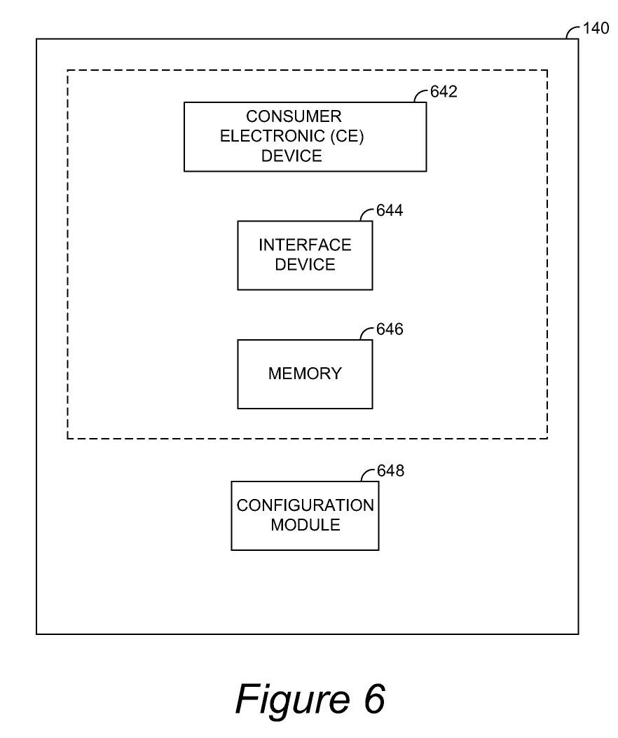

FIG. 3 is a diagram illustrating a more detailed example of a service provider 110 for delivering content to a user of a user platform that is preferably registered such as, for example, the user platform 140 of FIGS. 1 and 2. User platform 140 registration and/or device registration is further described below in relation to FIG. 6. As shown in FIG. 3, the service provider 110 comprises a data processor 111, a memory 113, a service provider database 112, a provision module 117, cross platform services component 116, and platform gateway 118. The provision module 117 may receive assets from various content sources such as, for example, the content sources 130 of FIGS. 1 and 2. The delivery of assets from the content source 130 may be via a wide-area data network 120 of FIGS. 1 and 2, such as the Internet. The assets may be received periodically, e.g., daily, in a batch mode operation or the provision module 117 may request assets from the content sources on demand or receive the assets in real time. In some embodiments, real time means as soon as the assets are available for delivery from the content source.

The assets may be temporarily stored in the memory 113 such as within a buffer, for example, from where the assets may be transferred and recorded in the service provider database 112, which may correspond, for example, to the service provider database 112 of FIG. 2. In operation, the data processor 111 may cause an interface device, such as, for example, the interface device 644 shown in FIG. 6 and described below, to present to a user of the user platform 140, information related to a number of content items retrieved from the assets. In an example embodiment, the data processor 111 may cause the provision module 117 to retrieve the content from the assets stored within the service provider database 112 and make the content accessible to the interface device 644 via the wide-area data network 120 of FIGS. 1 and 2, by using the platform gateway 118.

The platform gateway 118, which acts as an interface between the user platform 140 of FIGS. 1 and 2 and the service provider 110, may comprise software and/or hardware to translate between communication protocols used internally by the service provider 110 such as, for example, between the platform gateway 118 and the cross platform services component 116. These translated protocols may include, without limitation, a simple object access protocol (SOAP) and protocols used by the user platform 140 such as, for example, Internet Protocol (IP) and/or Transmission Control Protocol (TCP). The platform gateway 118 may receive, via the wide-area data network 120, from the user platform 140, a request by the user for content associated with the content source 130 of FIGS. 1 and 2.

The user may provide membership information regarding a membership with the content source 130 to the service provider 110, the first time the user attempts to access content from the content source 130, via the user platform 140. The membership information, for example, may include, but is not limited to, authentication information such as a username, a password and account identification, such as an account number and so forth. The membership information may be stored in the memory 113 in a member list associated with the content source 130 along with a registration code associated with the user platform 140 for future reference.

In later access attempts, the data processor 111 of the service provider 110 may determine that the user, and/or the user's user platform 140, has a membership with the content source 130, by referring to the member list associated with the content source 130 and the registration code of the user platform 140. Then, the data processor 111 may perform the authentication on behalf of the user, by using the stored authentication information, such that the user may access content from the content source 130 without explicit authentication being performed by the user.

Upon receiving the request for the content from the user platform 140, in a case that the processor 210 determines that the user does not have a membership with the content source 130, the processor 210 may cause the provision module 230 to automatically register the user with the content source 130. The processor 210 may cause the provision module 230 to receive an authentication token associated with the user from the content source 130 and invoke an interface associated with the content source by using the authentication token to register the user with the content source 130 and allow the user to access the content.

Regardless of the foregoing alternatives, accessing the content from the content source 130 can be achieved via several methods. For example, the data processor 111 may cause the provision module 117 to allow the user to receive delivery of the content directly from the content source 130 to the user platform 140. This embodiment is beneficial because the service provider 110 does not have to provision the resources necessary to store selected content for a plurality of users. In another embodiment, the data processor 111 causes the provision module 117 to retrieve the content from the assets stored in the service provider database 112, and allow the user to receive delivery of the content from the service provider 110. In this embodiment, the service provider 110 first retrieves the content from the content source 130 and stores the content as assets in the service provider database 112. This embodiment is beneficial because the service provider 110 can retain control over the content delivery process.

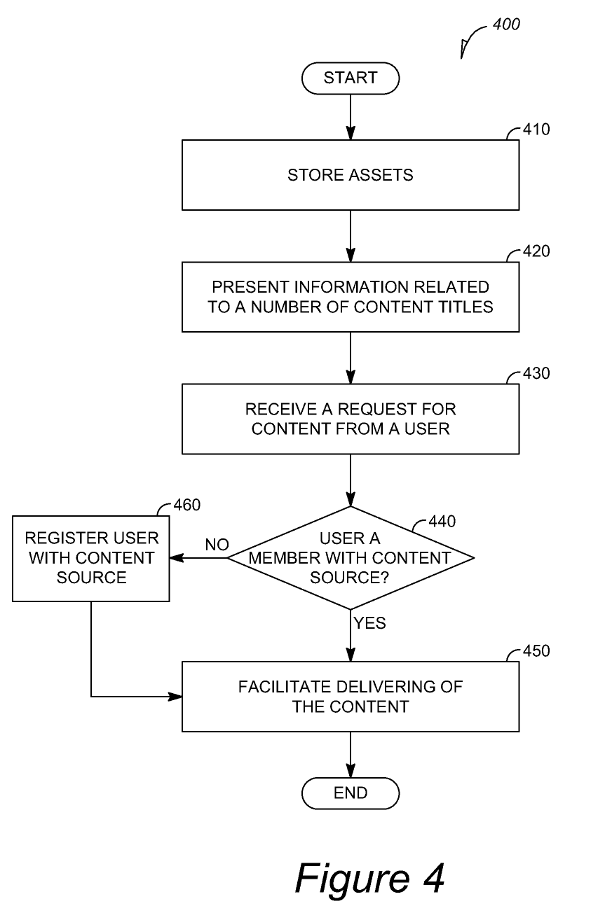

FIG. 4 is a flow diagram illustrating a further example method 400 of delivering content to a user of a user platform 140 of FIGS. 1 and 2, according to various embodiments. At an operation 410 shown in FIG. 4, assets or asset information received from the content source 130 may be stored in the service provider database 112 or memory 113. Information related to a number of content items retrieved from the assets can be presented, via the wide-area data network 120 of FIGS. 1 and 2, to a user of the user platform 140, at operation 420. The user determines if one or more of the content titles, presented as part of the content information, may be of interest. The user then submits a request for particular content titles to the service provider 110. The service provider 110, at operation 430, may receive a request from the user for one or more content items associated with the content source 130 from the user platform 140.

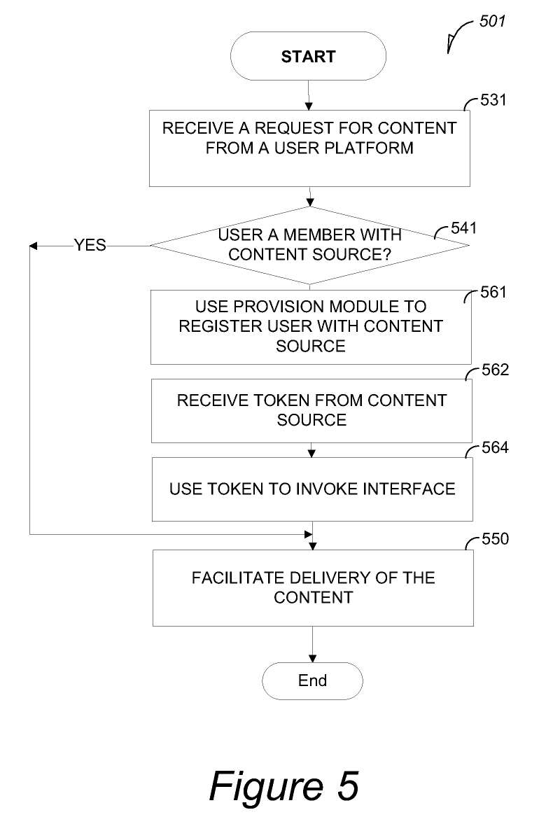

If it is determined at the control operation 440 that the user does not have a membership with the content source 130, and thus is not a user, then at operation 460, the data processor 111 causes the provision module 117 to automatically register the user with the content source 130. The registration of the user may proceed according to the steps described below in relation to FIG. 5.

If it is determined at the control operation 440 that the user does have a membership with the content source 130, and thus is a user, then at operation 450, the data processor 111 causes the provision module 117 to facilitate delivery of the requested content to the user without a need for explicit user authentication by the user. In order to skip explicit user authentication, upon receiving the request for content, the provision module 117 may receive an authentication token associated with the user from the content source 130 and invoke, by using the authentication token, an interface associated with the content source 130.

The provision module 117 may facilitate delivery of the requested content at operation 450 by allowing the user to download the content directly from the content source 130 on demand to the user platform 140. The provision module 117 may also retrieve the content from the assets stored in the service provider database 112 and allow the user to download the content from the service provider 110. Once registered with the content source 130, the user may download, stream, and/or receive content directly from the content source 130 to the user platform 140 without the need for explicit user authentication.

FIG. 5 is a flow diagram illustrating a further example method 501 of delivering content to a user of a user platform 140 of FIGS. 1 and 2, according to various embodiments. Preferably, the user platform 140 is registered. As shown in FIG. 5, a service provider 110 receives the request for the content from a user platform 140, at operation 531. If the data processor 111 determines, at operation 541, that the user does not have a membership with the content source, and thus is not a user, the data processor 111 may cause the provision module 117 to automatically register the user with the content source 130, at operation 561. For instance, the data processor 111 may cause the provision module 117 to receive an authentication token associated with the user from the content source 130, at operation 562, and invoke an interface associated with the content source by using the authentication token, at operation 564, to register the user with the content source 130 and allow the user to access the content, at operation 550.

More specifically, at operation 550, in response to receiving the request for content from the user platform 140, the data processor 111 may cause the provision module 117 to facilitate delivery of the content to the user, without a need for user authentication such as, for example, without the need for the user to login, provide a password, and/or provide payment or credit information, as described above. In some implementations, the provision module 117 is a software module, and the data processor 111 causes the software module to execute. With regard to registration of the user platform 140, the first time that a non-registered user platform 140 device is used, e.g., a consumer electronic (CE) device, television 142, or a digital video recorder (DVR) 143, the user may send a registration request. In another embodiment, the provision module 117 may automatically register the non-registered user platform 140 when the user platform 140 is coupled with the service provider 110 via a wide-area data network 120 for the first time. In one embodiment, for example, the provision module 117 provides the user with a registration code for the user platform 140. The user provides the registration code when the user explicitly registers the user platform 140 or refers to the user platform 140 in communications with the service provider 110. The user platform 140 of some embodiments is further described below with respect to FIG. 6.

### User Platform Registration

As mentioned above, the user platform 140 is preferably registered. The user platform registration or “device registration” operates alternatively, or in conjunction with, the “user registration” of some embodiments. User registration is used to identify and/or authorize a particular individual person for access to content via a user platform. User platform registration is used to identify and/or authorize a particular device or interface for access to content. Either or both types of registration can be used in various embodiments. FIG. 6 illustrates an example user platform 140, which may correspond to the user platform 140 shown in FIGS. 1 and 2. The user platform 140 preferably comprises a first consumer electronic (CE) device 642, such as the television 142 or the digital video recorder (DVR) 143 of FIG. 2, an interface device 644, a memory 646 and a configuration module 648. The memory 646 and/or the interface device 644 may be preconfigured within the television 142 and/or the digital video recorder 143. Alternatively, the memory 646 and/or the interface device 644 are added along with the configuration module 648 to form a non-registered user platform 140 that is enabled for registration. For instance, the memory 646 and/or the interface device 644 may optionally be coupled internally or externally to the television 142 and/or the digital video recorder 143.

As mentioned above, some user platforms 140 are initially not registered and require registration for operation with the service provider 110. In these cases, the first time that a user activates a non-registered user platform 140, the interface device 644 preferably communicates, via the wide-area data network 120, with the service provider 110. Once the non-registered user platform 140 communicates with the service provider 110, the configuration module 648 may work with the provision module 117 to register the non-registered user platform 140 with the service provider 110. When the registration is complete, the configuration module 648 may receive a registration code from the provision module 117. The configuration module 648 may then save the registration code in the memory 646 on the user platform 140. Once registered, the user platform 140 is ready to perform the functionalities described herein with respect to a registered user platform.

The interface device 644 may include hardware and/or software and may also provide various user interfaces to display a variety of information to the user. In an embodiment, the interface device 644 may receive the user interfaces from the service provider 110. The user interfaces, for example, may be used to display information related to a collection of content and associated metadata available from the service provider 110. The user interfaces may also provide for the user one or more search boxes to enable the user to search for content under a variety of listings such as title, artist, category, subject, company name, etc. For example, see United States Patent Application No. 2004/0073920 A1 for a sample interface in accordance with some embodiments. The interface device 644, as mentioned above, may also provide connectivity between the user platform 140 and the service provider 110, via the wide-area data network 120. Interactions between the user platform 140 and the components of the architectures shown in FIGS. 1 and 2 are discussed in more detail below.

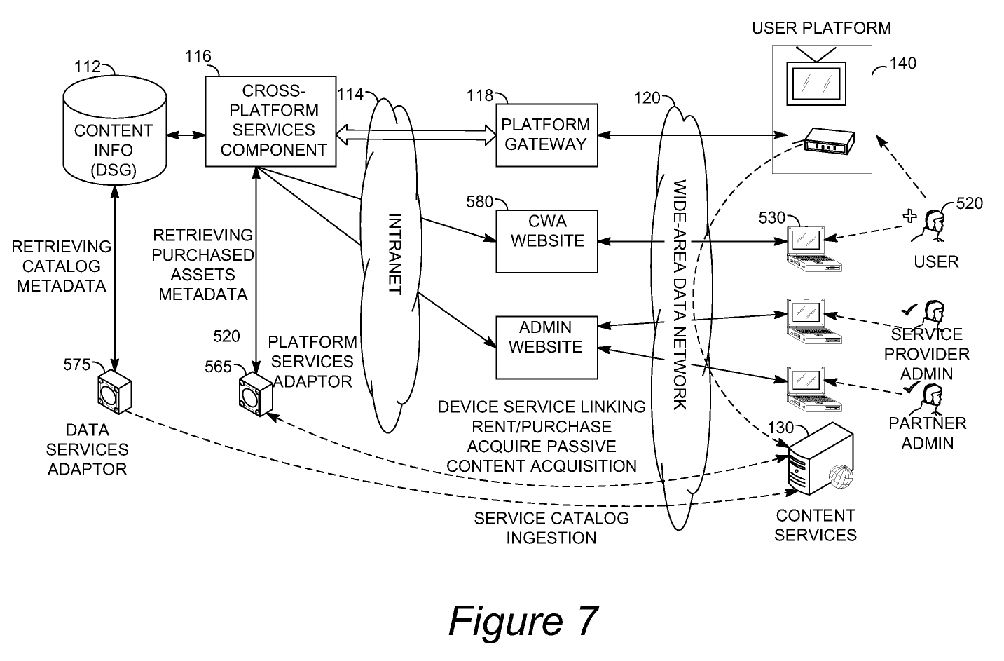

FIG. 7 illustrates example interactions between various entities of the architectures shown in FIGS. 1 and 2, according to various embodiments. The user 520 may use the registered user platform 140 to access content associated with the content source 130 via the service provider 110 of FIG. 1. As shown in FIG. 7, a platform gateway 118, intranet 114, cross-platform services component 116, a database 112 that includes “content information,” a platform services adaptor 565, and a data services adaptor 575, shown in FIG. 7, may be considered as a portion of the service provider 110. In some embodiments, the platform services adapter 565 and the data services adapter 575 are included in a cross platform services (CPS) group and/or a data services group (DSG) that are part of the service provider 110, such as Rovi Corporation, for example.

The user platform 140 may communicate with the service provider 110 via the wide-area data network 120, such as the Internet. On the service provider 110 side, the platform gateway 118 may handle communications with the user platform 140 by translating the communication protocols as described above with respect to FIG. 2. The cross-platform services component 116 and the database 112 may perform similar functions as discussed above with respect to the provision module 117 of FIG. 3. The cross-platform services component 116 may communicate with the content source 130 via the platform services adaptor 565, to receive, purchase, rent, and/or acquire content from the content source 130.

Also, the database 112 may use the data services adaptor 575 to ingest service catalogs from the content source 130. The service catalogs may include information including metadata related to a variety of content available through the content source 130. The platform services adaptor 565 and the data services adaptor 575 may facilitate communication with a number of content sources 130 such as, for example, Amazon, Netflix, Napster, CBS, and the like. Each content source 130 may use a different application programming interface (API). The platform services adapter 565 and the data services adapter 575 may aggregate various API's and protocols into a unified interface and protocol, which can be processed by the cross-platform services component 116 and the database 112. Hence, the platform services adapter 565 and/or the data services adapter 575 may be specific to the details of each content source server 540. As such, the specific detail of the interface with a particular content source 130 can be contained within a particular platform services adapter 565 and/or a data services adapter 575. Thus, the service provider 110 can be configured to support a wide variety of content sources 130.

A companion web application (CWA) website 580 shown in FIG. 7 may function as a user and partner portal and facilitate account linking and registration of a non-registered platform. In one embodiment, the first time that the user 520 begins using a non-registered platform, the user may use a computer 530 to couple to the CWA website 580 and request for the non-registered platform to be registered. After registration of the user 520 and/or the user platform 140, the user 520 does not need to use the CWA website 580 and may couple to the service provider 110 of FIG. 1 through the platform gateway 118, as described above. In another embodiment, a non-registered platform may be registered automatically such as when the non-registered platform is enabled and/or coupled to the environment 100 for the first time.

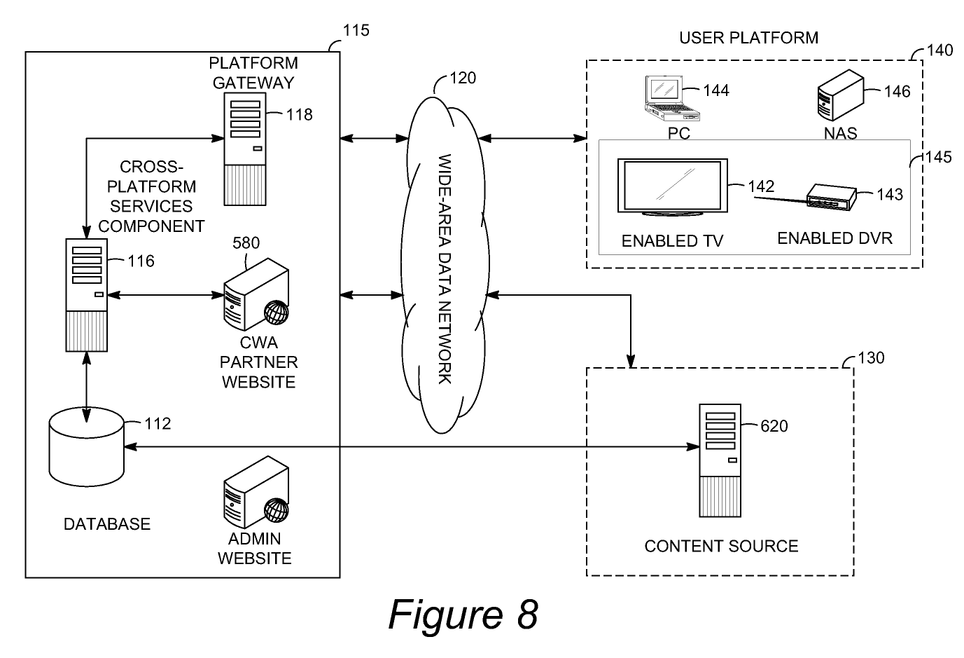

FIG. 8 is a diagram illustrating an example functional relationship between various modules of the architectures 100 and 101 shown in FIGS. 1 and 2, according to various embodiments. As shown in FIG. 8, the user may use a personal computer 144 to couple to the content source 130, via the wide-area data network 120 and/or to the network attached storage device 146, to access, download, and/or stream content. However, when the user accesses the hosted services 115 through a component of the user platform 140 such as, for example, the television 142 or the video recorder 143, the access and/or connection may be linked through the platform gateway 118 to the cross-platform services component 116.

As mentioned above, to register a non-registered platform including, for example, a television set and/or a video recorder, the user can access the CWA website 580 and request registration by using the personal computer 144. Alternatively, another enabled component of the user platform 140 is used to register the platform 140 and one or more components thereof. For instance, examples of optionally enabled components illustrated in FIG. 8 include a network attached storage device 146, a network enabled television 142, and a network enabled video recorder 143. Other enabled components and/or devices for coupling to wide-area data network 120 or another network are recognized, as well. Also shown in FIG. 8 is the interaction between the database system 112 and the content source 130, which may be provided via the wide-area data network 120 or through a direct dedicated link. Data communications between various entities in the architecture 100 or 101 may be facilitated by a number of applications as described below.

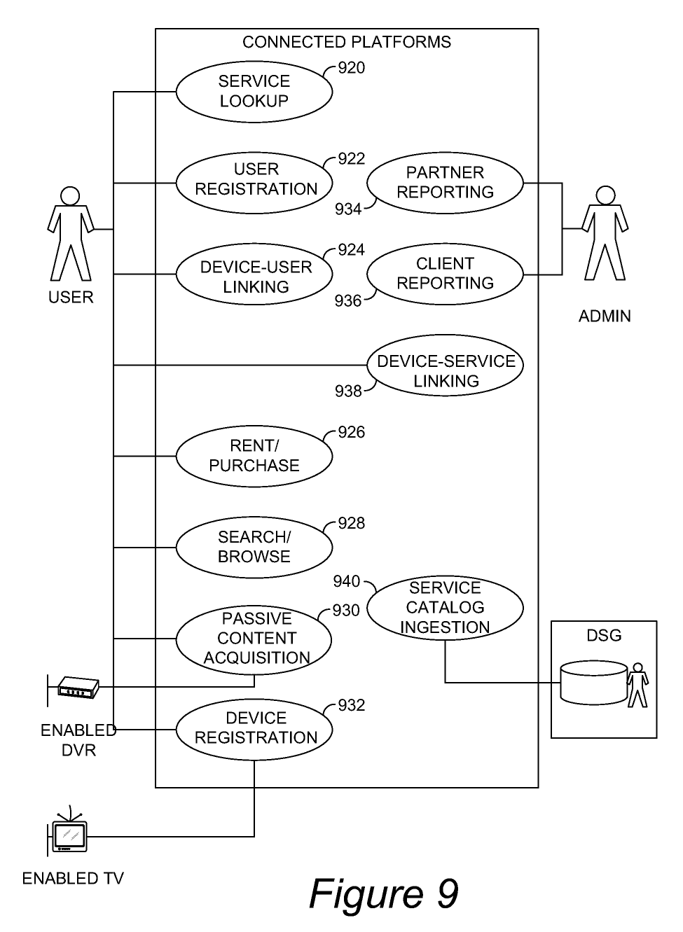

FIG. 9 is a diagram illustrating example applications facilitating device data communications for delivering content to a user of a user platform 140 of FIG. 1, according to various embodiments. As described above, the user platform 140 is preferably registered. A service look up application 920 may assist in a data communication in which a device “discovers” or queries for the Uniform Resource Locator (URL) appropriate for a particular data communication such as, for example, “what URL should I use when attempting to perform a data communication using version 1.0 of the SOAP protocol for device registration?” A user registration application 922 may be helpful in a data communication that results in the generation of a user account for a user of a service provider such as, for example, the service provider 110 of FIG. 1.

The device-user linking application 924 may facilitate a data communication that results in a device such as, for example, a device of the user platform 140 of FIG. 8 being associated with a particular service provider user account. A device-service linking application 938 may assist in a data communication that results in a device becoming associated with a content source such as, for instance, the content source 130 of FIG. 8. The device-service linking application 938 may further generate and/or register appropriate entities, including user accounts and/or devices with the content source 130. A passive content acquisition application 930 may facilitate a data communication by which a service provider's hosted service may become aware that a content item has been associated with a user platform 140 via a direct interaction with the content source 130.

A service catalog ingestion application 940 may assist in a data communication that allows a service provider's hosted infrastructure to act as a proxy for content and metadata associated with a content source's content catalogs. A search and/or browse application 928 may help in a data communication by which a device such as, for example, a user platform 140 or a companion web application discovers a content item made available via a third-party content source 130. A rent purchase application 926 may facilitate a data communication by which a device or a companion web application may acquire and/or schedule for downloading a content item made available via a content source 130. A device registration application 932 may assist in a data communication that results in a device such as, for example, a non-registered user platform 140 becoming registered with a service provider 110. A client reporting application 936 may help in a data communication by which a device attempts to notify a service provider's hosted infrastructure of interesting events. A partner reporting application 934 may facilitate a data communication by which a device attempts to notify a service provider's hosted infrastructure of interesting events.

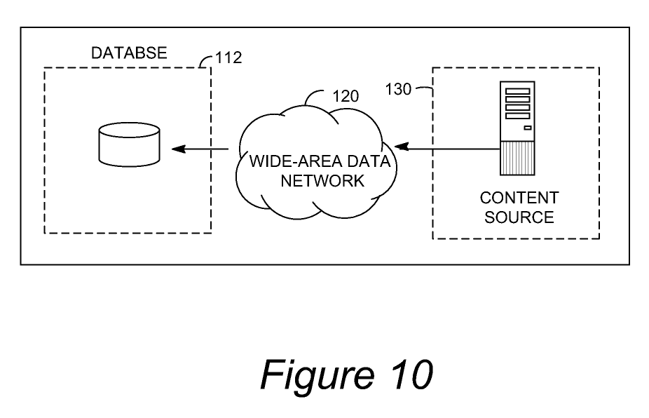

FIG. 10 is a diagram illustrating an example of periodic ingestion of service catalog data from a content source 130, according to various embodiments. The service-catalog data changes, as new content items are added, or older content items are removed. The database 112 may be periodically, e.g., daily, updated by receiving updated service catalog data, from the service provider 130, via the wide-area data network 120, for example.

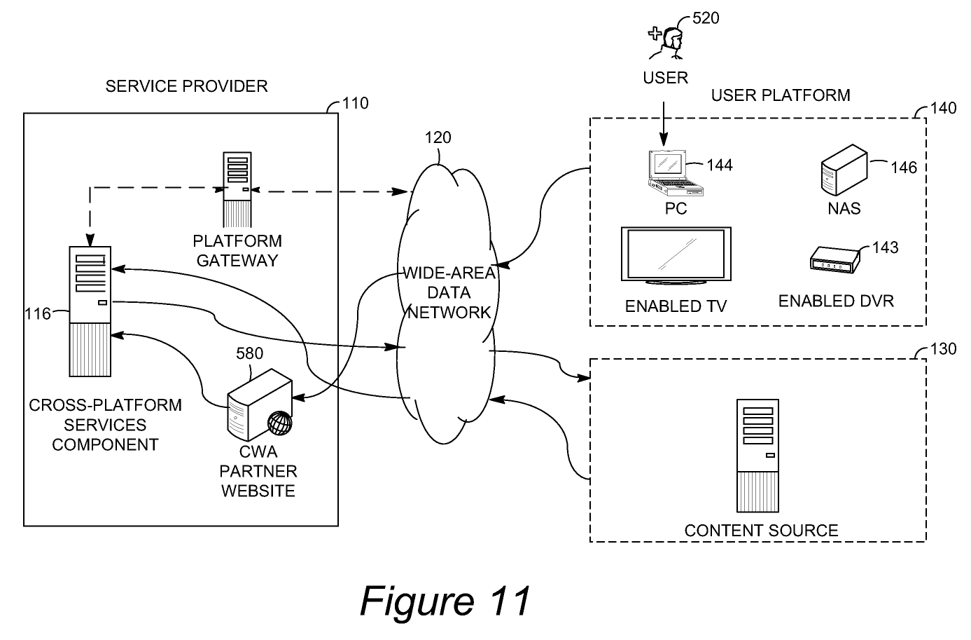

FIG. 11 is a diagram illustrating an example of registration and linking, according to various embodiments. In FIG. 11, a user 520 uses, for content access, a user platform 140 including one or more devices that are preferably registered such as, for example, a television 142 and/or a digital video recorder 143. The user 520 may have no accounts, or one or more accounts such as, for example, a membership account with one or more content sources 130. The user 520 may use the personal computer 144 to couple, via the wide-area data network 120, to the companion web application website 580 of a service provider 110 to provide account information for an account of the user 520 with the content source 130. The companion web application website 580 may receive the account information and request the cross-platform services component 116 to link a platform services account associated with the user 520 to the account of the user with the content source 130. The content source 130 may call the cross-platform services component 116 to retrieve information for the user platform 140 of the user 520, such as, for example, resolution, audio and/or video codec, and the like, so that the delivery of content from the content source 130 may be performed seamlessly without the need for the user to perform a different procedure and/or authentication for each content item available across the architecture 100 or 101, including the wide-area data network 120, the broadcast network 150, and/or the local network of the user platform 140.

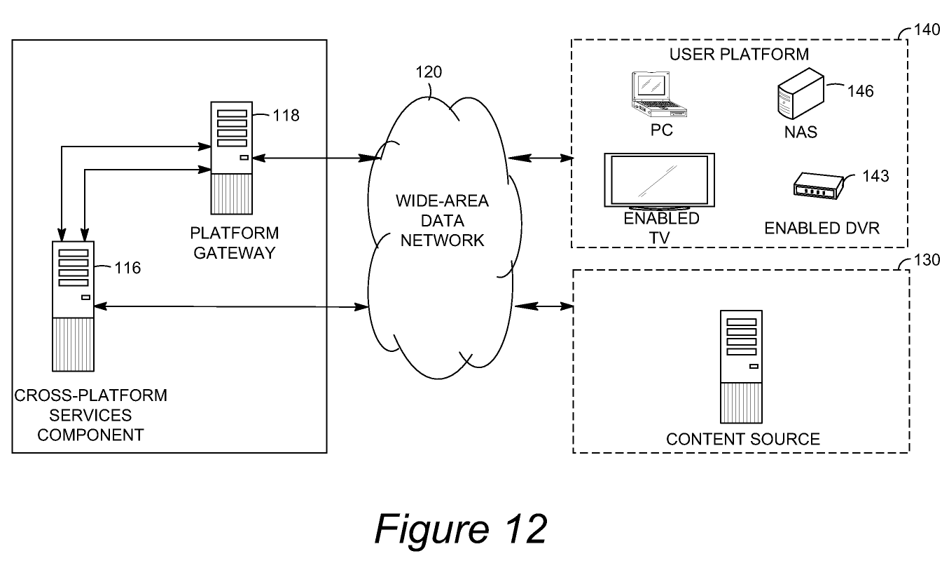

FIG. 12 illustrates an example account authentication, according to various embodiments. When a user starts using devices of a user platform 140 that are preferably registered such as, for example, a television 142 and/or a digital video recorder 143, the user platform 140 may automatically request an authentication token used for communication with a content source 130. The platform gateway 118, on behalf of the user and/or the user platform 140 may request the cross-platform services component 116 to retrieve an authentication token from the content source 130. The platform services adaptor 565 of FIG. 7 may provide required authentication information to the content source 130, via the wide-area data network 120, and acquire the authentication token. The platform services adaptor 565 may return the authentication token to the platform gateway 118, which may manage the token according to the requests made by the user.

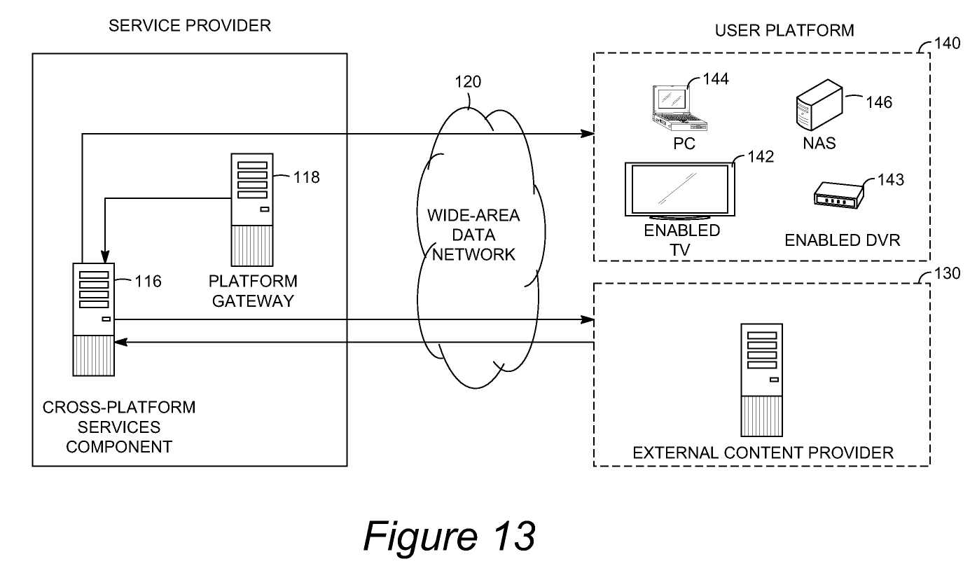

FIG. 13 illustrates an example workflow for delivery of a list of available content items to a user platform 140, according to various embodiments. The user platform 140 such as, for example, a television 142 and/or a digital video recorder 143, periodically receives an update of a list of available content items. The platform gateway 118 may query the cross-platform services component 116 to determine whether the list of available content items are available for the user platform 140. The cross-platform services component 116 may also check to see if requested data, that is, the list of available content items of a content source 130, is available. In the case the requested data is available, the cross-platform services component 116 may return the list of available assets through the platform gateway 118 to the user platform 140. Otherwise, if the requested data is not available, the cross-platform services component 116 may retrieve the requested data in real time, or immediately, via the wide-area data network 120, from the content source 130 and provide the requested data, via the platform gateway 118, to the user platform 140.

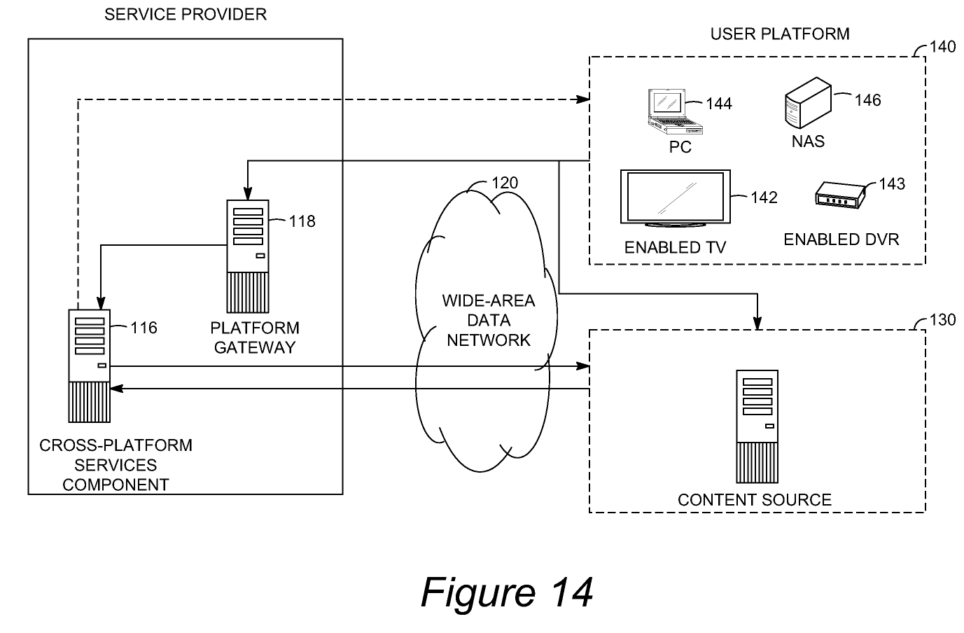

FIG. 14 illustrates an example of an e-commerce implementation for delivery of content to a user of a user platform 140, according to various embodiments. A user of a user platform 140, including a television 142, for example, may choose to buy a content item from a list of content resulting from a search and/or browse operation. The user may click on a Buy button for the content item. As a result of the activation of the Buy button, the user platform 140 may communicate a buy message to the platform gateway 118. The platform gateway 118 may translate the buy message and send a buy request for the content item to the cross-platform services component 116.

As a result of receiving the buy request from the platform gateway 118, the cross-platform services component 116 may invoke an appropriate API call to the corresponding content source 130 to acquire the requested content item. The content source 130 may return a success code and metadata for accessing, downloading, and/or streaming the requested content item by the user. The cross-platform services component 116 may then return the metadata for accessing, downloading, and/or streaming of the purchased content item to the user platform 140 through the platform gateway 118. Using the metadata, the user may access, download and/or stream the purchased content item to the user platform 140. It may also be possible for a user of the user platform 140 to access, download and/or stream the purchased content directly from the content source 130, via the wide-area data network 120, as described below.

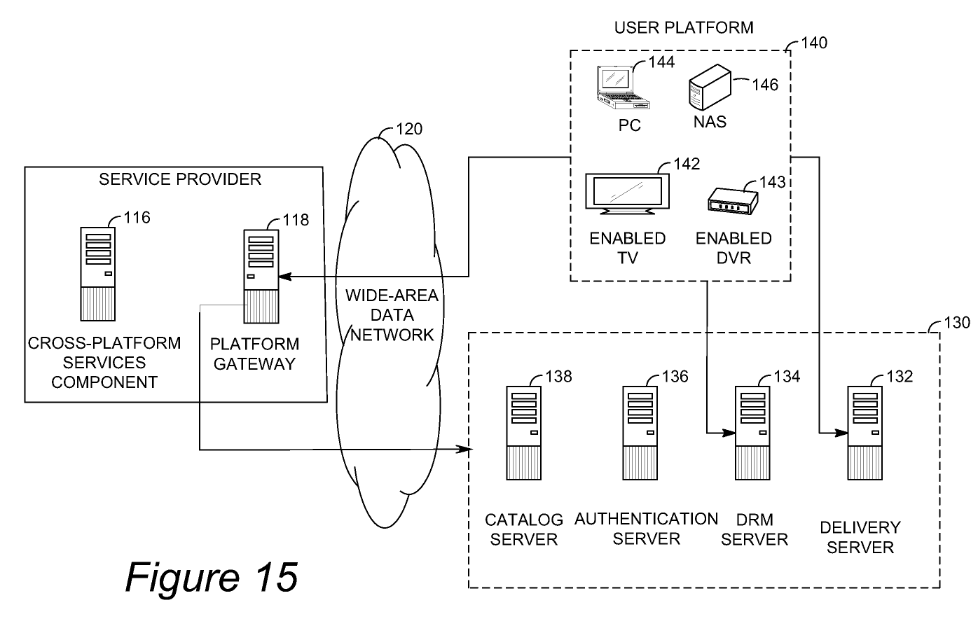

FIG. 15 illustrates an example of direct access, and/or content delivery from a content source 130, according to various embodiments. In an embodiment, a user interface that includes a Play button is provided to the user of a television 142 of a user platform 140. The Play button may allow the user to access, download and/or stream content directly from the content source 130, via the wide-area data network 120. Once the user selects a content item from a list, the user may click on the Play button to access the content. Clicking on the Play button may initiate delivery, e.g., streaming, and/or downloading of the content from the delivery server 132 of the content source 130. The user platform 140 may also acquire digital rights for the content from the digital rights management (DRM) server 134 of the content source 130. While accessing, downloading, and/or streaming the content, the user platform 140 may send status messages to the platform gateway 118. The platform gateway 118 may forward the status messages to the content source 130. In a particular embodiment, the user platform 140 may also need to acquire an authentication token from the authentication server 136 of content source 130. The authentication token enables the user platform 140 devices to access, play, and/or record the content items acquired from the content source 130. A catalog server 138 of content source 130 provides a list of content items that are available at the content source 130. The content list can be downloaded to the user platform 140 for display to a user of the user platform 140. This list of content from content source 130 can be viewed in a search and/or browse operation performed at the user platform 140. The content list can also include Buy buttons for particular content items that are available for purchase by the user of user platform 140.

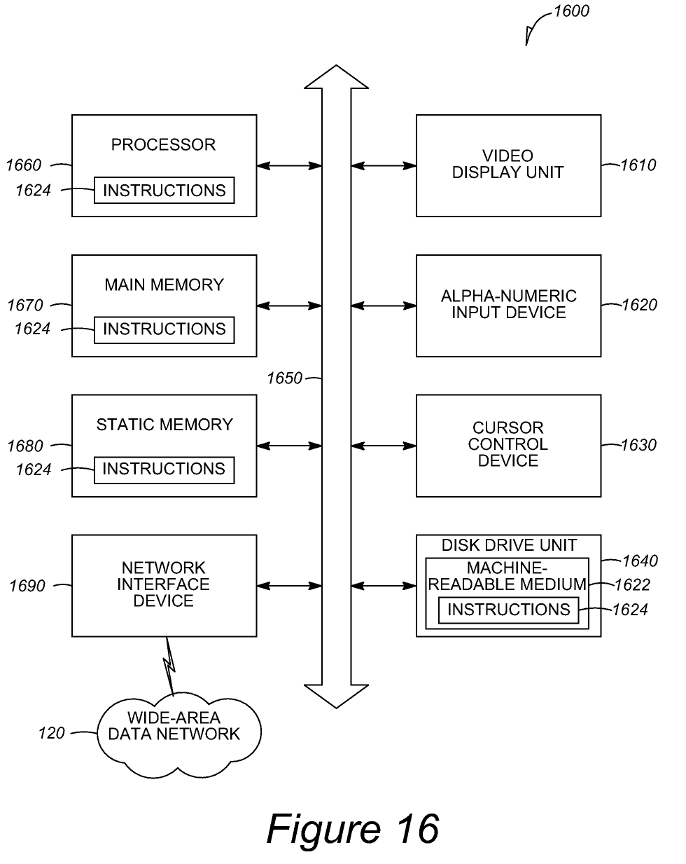

FIG. 16 illustrates a system 1600 that may be used with the architecture for delivering content in the example form of a computer system. Within the system 1600 a set of instructions for causing the system 1600 to perform one or more of the methodologies discussed herein may be executed. In alternative embodiments, the system 1600 may operate as a standalone device or may be coupled such as, for example, networked to other apparatus. In a networked deployment, the system 1600 may operate in the capacity of a server or a client apparatus in a server-client network environment, or as a peer apparatus in a peer-to-peer, or distributed, network environment.

The example system 1600 may include a processor 1660 such as, for example, a central processing unit (CPU), a graphics processing unit (GPU) or both, a main memory 1670 and a static memory 1680, all of which communicate with each other via a bus 1650. The system 1600 may further include a video display unit 1610 such as, for example, a liquid crystal display (LCD) or cathode ray tube (CRT). The system 1600 may also include an alphanumeric input device 1620 such as, for example, a keyboard, a cursor control device 1630 such as a mouse, a disk drive unit 1640, and a network interface device 1690.

The disk drive unit 1640 may include a machine-readable medium 1622 on which is stored one or more sets of instructions such as, for example, software 1624 embodying any one or more of the methodologies or functions described herein. The instructions 1624 may also reside, completely or at least partially, within the main memory 1670 and/or within the processor 1660 during execution thereof by the system 1600, with the main memory 1670 and the processor 1660 also constituting machine-readable media. The instructions 1624 may further be transmitted or received over a wide-area data network 120 via the network interface device 1690.

While the machine-readable medium 1622 is shown in an example embodiment to be a single medium, the term “machine-readable medium” should be taken to include a single medium or multiple media such as, for example, a centralized or distributed database, and/or associated caches and servers that store the one or more sets of instructions. The term “machine-readable medium” shall also be taken to include any medium that is capable of storing, encoding, or carrying a set of instructions for execution by the apparatus and that cause the apparatus to perform any one or more of the methodologies of the present technology. The term “machine-readable medium” shall accordingly be taken to include, but not be limited to, solid-state memories and optical and magnetic media.

Embodiments for delivering content to a user of a registered platform have been described. Although the present embodiments have been described, it is evident that various modifications and changes may be made to these embodiments. Accordingly, the specification and drawings are to be regarded in an illustrative rather than a restrictive sense.

The Abstract of the Disclosure is provided to comply with 37 C.F.R. §1.72(b), requiring an abstract that allows the reader to quickly ascertain the nature of the technical disclosure. It is submitted with the understanding that it is not to be used to interpret or limit the claims. In addition, in the foregoing Detailed Description, it may be seen that various features are grouped together in a single embodiment for the purpose of streamlining the disclosure. This method of disclosure is not to be interpreted as limiting the claims. Thus, the following claims are hereby incorporated into the Detailed Description, with each claim standing on its own as a separate embodiment.

What is claimed is:

1. A method comprising:
storing assets received from a content source in a database;
presenting, via a network, to a user of a registered user platform, information related to a plurality of content items retrieved from the assets;
receiving, via the network, from the registered platform, a request by the user for content associated with the content source;
determining that the user has a membership with the content source; and
facilitating delivering of the content to the user, without a need for a user authentication.

2. The method of claim 1, further comprising enabling a consumer electronic device to operate as a registered user platform.

3. The method of claim 2, wherein the enabling of the consumer electronic device comprises installing at least one of a hardware or software.

4. The method of claim 1, further comprising the receiving, via a network, of a registration request for a non-registered platform.

5. The method of claim 1, wherein the presenting comprises displaying a user interface provided by a server.

6. The method of claim 5, further comprising the presenting, via the user interface, of content categories and content metadata.

7. The method of claim 5, wherein the receiving of the request comprises the receiving, via the user interface, of at least one of a keyword associated with a content item, a name of a content source, a name of a person, or a category.

8. The method of claim 1, wherein the content comprises, digital content including at least one of electronic publications including electronic books, electronic journals, electronic newspapers, electronic catalogs, and electronic advertisements or multimedia content including audio and video content items.

9. The method of claim 1, further comprising automatically registering the user with the content source, when a determination is made that the user lacks the membership with the content source.

10. The method of claim 1, further comprising:
receiving an authentication token associated with the user from the content source; and
invoking an interface associated with the content source by using the authentication token upon receiving of the request.

11. The method of claim 1, wherein the assets comprise at least one of a plurality of content items or information related to the plurality of content items.

12. The method of claim 11, wherein the facilitating of the delivering comprises at least one of:
allowing the user to deliver the content to the registered platform;
allowing the user to download the content directly from a content source server on demand;
allowing the user to stream the content; or
retrieving the content by a server from the assets stored in the database and allowing the user to download the content from the server.

13. The method of claim 12, further comprising receiving the assets, by the server, from the content source, and wherein the information related to the plurality of content items comprises a service catalog including a content list and metadata.

14. A system comprising:
memory to store assets received from a content source in a database;
a processor to cause, via a network, an interface device to present to a user of a registered platform, information related to a plurality of content items retrieved from the assets;
a gateway to receive, via the network, from the registered platform, a request by the user for content associated with the content source;
the processor to determine that the user has a membership with the content source; and
the processor to cause a provision module to facilitate delivering of the content to the user, without a need for user authentication.

15. The system of claim 14, wherein the gateway is to receive, via the network, a registration request for a non-registered platform.

16. The system of claim 14, wherein the gateway is to receive, via the network, at least one of a keyword associated with a content item, a name of a content source, a name of a person, or a category.

17. The system of claim 14, wherein the processor is to cause the provision module to automatically register the user with the content source, when a determination is made that the user lacks the membership with the content source.

18. The system of claim 14, wherein the processor is to cause the provision module to:
receive an authentication token associated with the user from the content source; and
invoke an interface associated with the content source by using the authentication token upon receiving of the request.

19. The system of claim 14, wherein the assets comprise at least one of a plurality of content items or information related to the plurality of content items.

20. The system of claim 19, wherein the processor is to cause the provision module to perform at least one of:
allowing the user to receive the content to the registered platform;
allowing the user to receive the content directly from a content source server on demand;
allowing the user to stream the content;
retrieving the content by a server from the assets stored in the database and allowing the user to receive the content from the server; or
receiving the assets from the content source, wherein the information related to the plurality of content items comprises a service catalog including a content list and metadata.

21. An apparatus comprising:
a consumer electronic (CE) device;
an interface device;
a configuration module to configure the CE device to:
register the CE device with a service provider;
present, via the interface device, to a user of the CE device, information related to a plurality of content items retrieved from assets stored in a database associated with the service provider;
transmit to the service provider, via a network, a request by the user for content;
receive the content, via the network, from the service provider without a need for user authentication; and
present, via the user interface device, the content to the user.

22. The apparatus of claim 21, further including memory to store at least one of the content or content metadata.

23. A computer-readable medium storing instructions, which when executed by one or more processors cause a computer to perform a method of configuring a consumer electronic (CE) device, the method comprising:
registering the CE device with a service provider;
presenting, via a user interface device, to a user of the CE device, information related to a plurality of content items retrieved from assets stored in a database associated with the service provider;
transmitting to the service provider, via the network, a request by the user for content;
receiving the content, via the network, from the service provider without a need for user authentication; and
presenting, via the user interface device, the content to the user.
